(19) United States
(12) Patent Application Publication
(10) Pub. No.: US 2023/0058922 A1
(43) Pub. Date: Feb. 23, 2023

(54) APPLIANCE WITH COLLOCATED CAMERAS

(71) Applicant: Haier US Appliance Solutions, Inc., Wilmington, DE (US)

(72) Inventor: Michael Goodman Schroeder, Louisville, KY (US)

(21) Appl. No.: 17/404,188

(22) Filed: Aug. 17, 2021

(51) Int. Cl. H04N 5/247; F25D 11/02; H04N 7/18

(52) U.S. Cl. CPC H04N 5/247; F25D 11/02; H04N 7/18; F25D 2400/36; F25D 2500/06; F25D 2700/06

(57) ABSTRACT

An appliance includes a cabinet that defines an interior chamber. A plurality of collocated camera assemblies is mounted to the cabinet at the interior chamber. The plurality of collocated camera assemblies is oriented for capturing images of a plane in the interior chamber. The appliance may be a refrigerator appliance, and the interior chamber may be a fresh food chamber.

### FIELD OF THE INVENTION

The present subject matter relates generally to appliances with integrated cameras.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Notably, it is frequently desirable to have an updated inventory of items that are present within the refrigerator appliance, e.g., to facilitate reorders, to ensure food freshness or avoid spoilage, etc. Thus, it may be desirable to monitor food items that are added to or removed from refrigerator appliance and obtain other information related to the presence, quantity, or quality of such food items. Certain conventional refrigerator appliances have systems for monitoring food items in the refrigerator appliance. However, such systems often require user interaction, e.g., via direct input through a control panel as to the food items added or removed. By contrast, certain appliances include a camera for monitoring food items as they are added or removed from the refrigerator appliance. However, conventional camera systems may have trouble identifying a particular object, distinguishing between similar products, and precisely identifying the location of an object within the chilled chamber.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance includes a cabinet that defines a fresh food chamber and a freezer chamber. A plurality of collocated camera assemblies is mounted at the fresh food chamber. The plurality of collocated camera assemblies is oriented for capturing images of a plane in the fresh food chamber.

In another exemplary embodiment, an appliance includes a cabinet that defines an interior chamber. A plurality of collocated camera assemblies is mounted at the interior chamber. The plurality of collocated camera assemblies is oriented for capturing images of a plane in the interior chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a refrigerator appliance according to an example embodiment of the present subject matter.

FIG. 2 is a perspective view of the example refrigerator appliance of FIG. 1, with the doors of the fresh food chamber shown in an open position.

FIG. 3 is a schematic view of certain components of the example refrigerator appliance of FIG. 1.

FIG. 4 is a pixel map for a collocated camera system of the example refrigerator appliance of FIG. 1.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

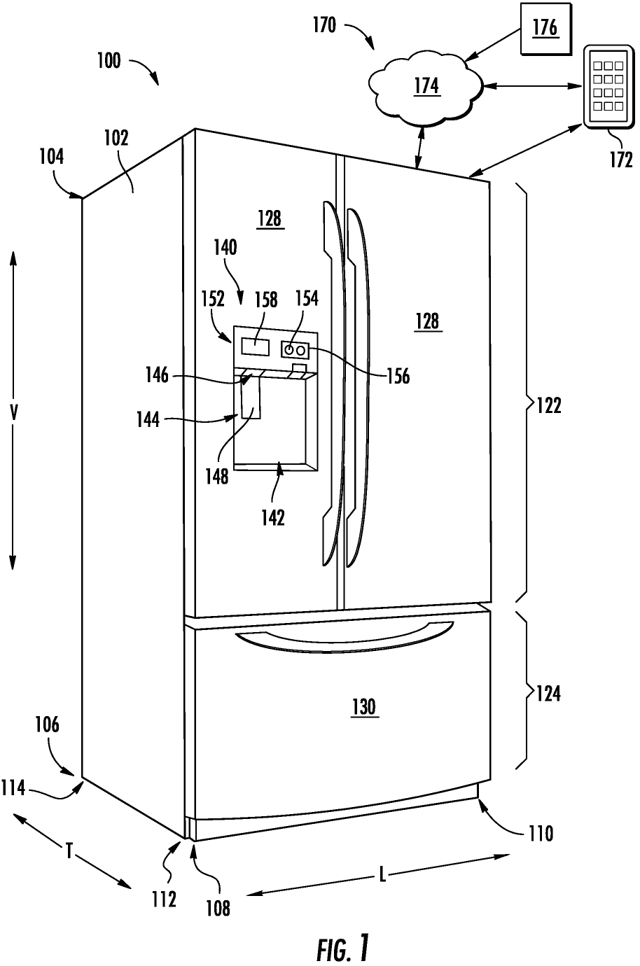

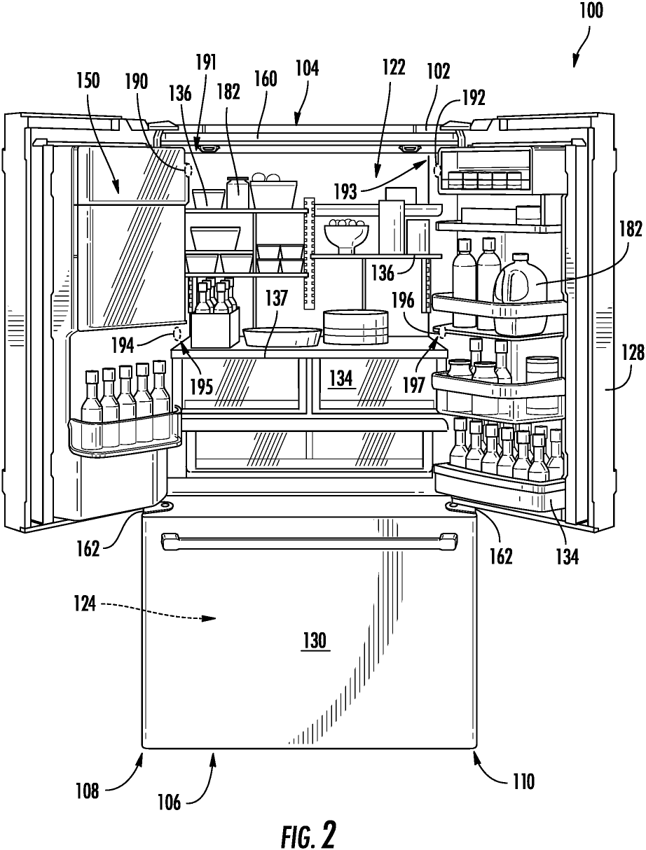

Referring now to the figures, an example appliance will be described in accordance with example aspects of the present subject matter. Specifically, FIG. 1 provides a perspective view of an example refrigerator appliance 100, and FIG. 2 illustrates refrigerator appliance 100 with some of the doors in the open position. As illustrated, refrigerator appliance 100 generally defines a vertical direction V, a lateral direction L, and a transverse direction T that are mutually perpendicular and form an orthogonal coordinate system.

According to example embodiments, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top portion 104 and a bottom portion 106 along the vertical direction V, between a first side portion 108 (e.g., the left side when viewed from the front as in FIG. 1) and a second side portion 110 (e.g., the right side when viewed from the front as in FIG. 1) along the lateral direction L, and between a front portion 112 and a rear portion 114 along the transverse direction T. In general, terms such as “left,” “right,” “front,” “rear,” “top,” or “bottom” are used with reference to the perspective of a user accessing appliance 100. As shown in FIG. 2, cabinet 102 may include a top wall 160 and a pair of side walls 162, e.g., that are spaced apart along the lateral direction L.

Cabinet 102 defines chilled chambers for receipt of food items for storage. In particular, cabinet 102 defines fresh food chamber 122 positioned at or adjacent top portion 104 of cabinet 102 and a freezer chamber 124 arranged at or adjacent bottom portion 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of cabinet 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. In general, refrigerator doors 128 form a seal over a front opening 132 defined by cabinet 102. In this regard, a user may place items within fresh food chamber 122 through front opening 132 when refrigerator doors 128 are open and may then close refrigerator doors 128 to facilitate climate control. Refrigerator doors 128 and freezer door 130 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Turning back to FIG. 1, a dispensing assembly 140 is generally configured for dispensing liquid water and/or ice. Dispensing assembly 140 and its various components may be positioned at least in part within a dispenser recess 142 defined on one of refrigerator doors 128. In this regard, dispenser recess 142 is defined on a front portion 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible by a processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as an external device 172. As described in more detail below, these communications may be facilitated using a wired or wireless connection, such as via a network 174. In general, external device 172 may be any suitable device separate from refrigerator appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with refrigerator appliance 100 and/or external device 172 through network 174. In this regard, for example, remote server 176 may be a cloud-based server 176, and is thus located at a distant location, such as in a separate city, state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information. According to exemplary embodiments, remote server 176 may be configured to receive and analyze images obtained by collocated camera assemblies 190, 192, 194, 196 of refrigerator appliance 100, e.g., to facilitate inventory analysis.

In general, communication between refrigerator appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring now generally to FIG. 2, refrigerator appliance 100 may further include an inventory management system that is generally configured to monitor one or more chambers of refrigerator appliance 100 to monitor the addition or removal of inventory. More specifically, as described in more detail below, the inventory management system may include a plurality of sensors, cameras, or other detection devices that are used to monitor fresh food chamber 122 to detect objects (e.g., identified generally by reference numeral 182) that are positioned in or removed from fresh food chamber 122. In this regard, the inventory management system may use data from each of these devices to obtain a complete representation or knowledge of the identity, position, and/or other qualitative or quantitative characteristics of objects 182 within fresh food chamber 122. Although the inventory management system is described herein as monitoring fresh food chamber 122 for the detection of objects 182, it should be appreciated that aspects of the present subject matter may be used to monitor objects or items in any other suitable appliance, chamber, etc.

As shown schematically in FIG. 2, the inventory management system includes a plurality of collocated camera assemblies that are generally positioned and configured for obtaining images of refrigerator appliance 100 during operation. Specifically, the inventory management system includes collocated camera assemblies, including, a first collocated camera assembly 190, a second collocated camera assembly 192, a third collocated camera assembly 194, and a fourth collocated camera assembly 196, that are mounted to cabinet 102 or are otherwise positioned in view of fresh food chamber 122. Although the four collocated camera assemblies 190, 192, 194, 196 are described herein as being used to monitor fresh food chamber 122 of refrigerator appliance 100, it should be appreciated that aspects of the present subject matter may include other suitable numbers and arrangements of collocated camera assemblies used to monitor any other suitable regions of any other suitable appliance, e.g., such as freezer chamber 124.

As best shown in FIG. 2, each of the collocated camera assemblies 190, 192, 194, 196 is mounted to cabinet 102 at front opening 132 of fresh food chamber 122 and is oriented to have a field of view directed across front opening 132 and/or into fresh food chamber 122. The collocated camera assemblies 190, 192, 194, 196 may be used to facilitate an inventory management process for refrigerator appliance 100. As such, the collocated camera assemblies 190, 192, 194, 196 may be positioned at an opening to fresh food chamber 122 to monitor food items (identified generally as objects 182) that are being added to or removed from fresh food chamber 122. One or more (e.g., all) of the collocated camera assemblies 190, 192, 194, 196 may also include a microphone for capturing audio.

As shown in FIG. 2, the collocated camera assemblies 190, 192, 194, 196 may be mounted to cabinet 102 at a front portion of fresh food chamber 122, e.g., adjacent front opening 132 and/or front portion 112 of cabinet 102. For instance, fresh food chamber 122 may include a first corner 191, a second corner 193, a third corner 195, and a fourth corner 197. Thus, e.g., fresh food chamber 122 may have a rectangular cross-section, e.g., in a plane that is perpendicular to the transverse direction T. First collocated camera assemblies 190 may be positioned at first corner 191, second collocated camera assemblies 192 may be positioned at second corner 193, third collocated camera assemblies 194 may be positioned at third corner 195, and fourth collocated camera assemblies 196 may be positioned at fourth corner 197. First and second corners 191, 193 of fresh food chamber 122 may be positioned at a respective interface between top wall 160 and side walls 162 (e.g., where top wall 160 intersects each of side walls 162). Third and fourth corners 195, 197 may be positioned below first and second corners 191, 193, e.g., along the vertical direction V. For instance, third and fourth corners 195, 197 may be positioned at a respective interface between a bottommost shelf 137 in fresh food chamber 122 and sidewalls 162 (e.g., where the bottommost shelf 137 meets or is positioned at each of side walls 162). The bottommost shelf 137 may be positioned directly over bins 134 and/or formed by the top of bins 134. First and second collocated camera assemblies 190, 192 may be positioned above shelves 136 in fresh food chamber 122, and third and fourth 194, 196 may be positioned at bottommost shelf 137 in fresh food chamber 122.

First and second collocated camera assemblies 190, 192 may be positioned at a common vertical height within fresh food chamber 122. For example, first and second collocated camera assemblies 190, 192 may be positioned no more than eight centimeters from top wall 160. Third and fourth collocated camera assemblies 194, 196 may also be positioned at a common vertical height (e.g., different than that of the first and second collocated camera assemblies 190, 192) within fresh food chamber 122. For example, third and fourth collocated camera assemblies 194, 196 may be positioned no more than eight centimeters from bottommost shelf 137. First and third collocated camera assemblies 190, 194 may be positioned at a common lateral position within fresh food chamber 122. For example, first and third collocated camera assemblies 190, 194 may be positioned no more than eight centimeters from a first one of side walls 162. Second and fourth collocated camera assemblies 192, 196 may be positioned at a common lateral position (e.g., different than first and third collocated camera assemblies 190, 194) within fresh food chamber 122. For example, second and fourth collocated camera assemblies 192, 196 may be positioned no more than eight centimeters from a second one of side walls 162. As may be seen from the above, first collocated camera assemblies 190 may be positioned proximate the top and first side portions of fresh food chamber 122, second collocated camera assemblies 192 may be positioned proximate the top and second side portions of fresh food chamber 122, third collocated camera assemblies 194 may be positioned proximate the bottom and first side portions of fresh food chamber 122, and fourth collocated camera assemblies 196 may be positioned proximate the bottom and second side portions of fresh food chamber 122. In certain example embodiments, the collocated camera assemblies 190, 192, 194, 196 may be positioned coplanar with one another in a plane that is perpendicular to the transverse direction T.

Collocated camera assemblies include at least two, separate cameras located in close proximity to each other, e.g., no more than five centimeters (5 cm) apart. Moreover, the two, separate cameras may be oriented in the same general direction. In certain example embodiments, each of collocated camera assemblies 190, 192, 194, 196 may include two image sensors and two lenses located in close proximity to each other. The two image sensors in each of collocated camera assemblies 190, 192, 194, 196 may be different or may be identical. Similarly, the two lenses in each of collocated camera assemblies 190, 192, 194, 196 may be different or may be identical. However, e.g., the two, separate cameras in each of collocated camera assemblies 190, 192, 194, 196 may have a different focal length. The collocated camera assemblies 190, 192, 194, 196 may not include autofocus lenses in certain example embodiments. As may be seen from the above, each collocated camera assemblies may include at least two cameras, such as two, three, four or more cameras.

Each of the cameras in collocated camera assemblies 190, 192, 194, 196 may have a resolution no greater than three megapixels (3 MP). Thus, e.g., the cameras in collocated camera assemblies 190, 192, 194, 196 may be relatively low resolution. However, because each of the collocated camera assemblies 190, 192, 194, 196 includes at least two, separate cameras located in close proximity to each other, a high focus region of collocated camera assemblies 190, 192, 194, 196 may be significantly larger than using multiple, single cameras spaced remotely from one another. For example, collocated camera assemblies may have a high focus region that is about fifty percent (50%) larger than a single camera. Thus, e.g., despite using relatively low-resolution cameras, images from collocated camera assemblies 190, 192, 194, 196 may be used for classification of objects 182, reading text on objects 182, reading barcodes on objects 182, etc. For comparison, four collocated camera assemblies 190, 192, 194, 196 each with two, two megapixel cameras (i.e., eight total, two megapixel cameras) may provide similar resolution as four, eight megapixel cameras. Moreover, less data may be output from collocated camera assemblies, thus reducing the required computing power required to analyze images from collocated camera assemblies relative to high-resolution single cameras. It will be understood that each of the cameras in collocated camera assemblies 190, 192, 194, 196 may have a higher resolution in alternative example embodiments. For instance, each of the cameras in collocated camera assemblies 190, 192, 194, 196 may have a resolution no greater than eight megapixels (8 MP).

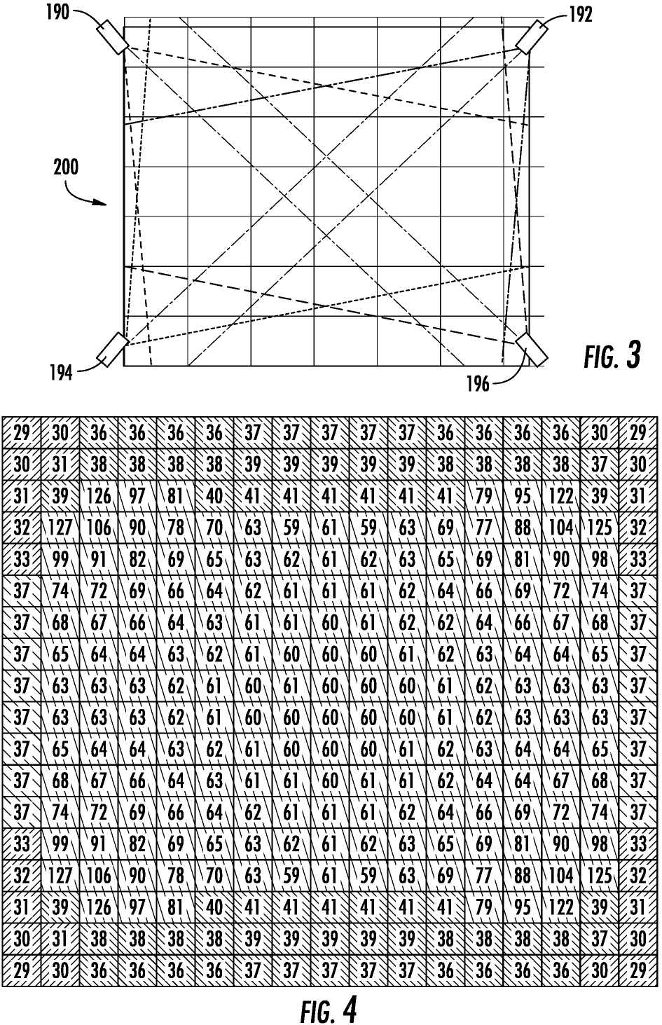

As shown in FIG. 3, the collocated camera assemblies 190, 192, 194, 196 may be oriented for capturing images of a plane 200, e.g., that is perpendicular to the transverse direction T. FIG. 4 shows the pixels per inch captured by the collocated camera assemblies 190, 192, 194, 196 for the plane 200. As shown in FIG. 4, the collocated camera assemblies 190, 192, 194, 196 may take high-quality images of the plane 200 for no less than sixty percent (60%) of the plane 200. Images from the collocated camera assemblies 190, 192, 194, 196 that have no less than one hundred and fifty pixels per centimeter (150 p/cm) and/or no less than sixty pixels per inch (60 p/in) may be considered high-quality as used herein. High-quality images may be used for classification of objects 182, reading text on objects 182, reading barcodes on objects 182, etc. The arrangement of the four collocated camera assemblies 190, 192, 194, 196 described above may advantageously assist with providing high-quality images for inventory analysis purposes.

It should be appreciated that the images obtained by the collocated camera assemblies 190, 192, 194, 196 may vary in number, frequency, angle, resolution, detail, etc. in order to improve the clarity of the particular regions surrounding or within refrigerator appliance 100. In addition, according to exemplary embodiments, controller 156 may be configured for illuminating the chilled chamber using one or more light sources prior to obtaining images. Notably, controller 156 of refrigerator appliance 100 (or any other suitable dedicated controller) may be communicatively coupled to collocated camera assemblies 190, 192, 194, 196 and may be programmed or configured for analyzing the images obtained by collocated camera assemblies 190, 192, 194, 196, e.g., in order to identify items being added or removed from refrigerator appliance 100.

In general, controller 156 may be operably coupled to the collocated camera assemblies 190, 192, 194, 196 for analyzing one or more images obtained by the collocated camera assemblies 190, 192, 194, 196190, 192, 194, 196 to extract useful information regarding objects 182 located within fresh food chamber 122. In this regard, for example, images obtained by the collocated camera assemblies 190, 192, 194, 196 may be used to extract a barcode, identify a product, monitor the motion of the product, or obtain other product information related to object 182. Notably, this analysis may be performed locally (e.g., on controller 156) or may be transmitted to a remote server (e.g., remote server 176 via external communication network 170) for analysis. Such analysis is intended to facilitate inventory management, e.g., by identifying a food item being added to or removed from the chilled chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a fresh food chamber and a freezer chamber; and
a plurality of collocated camera assemblies mounted at the fresh food chamber, the plurality of collocated camera assemblies oriented for capturing images of a plane in the fresh food chamber.

2. The refrigerator appliance of claim 1, wherein each of the plurality of collocated camera assemblies comprises two cameras with different focal lengths.

3. The refrigerator appliance of claim 2, wherein each of the two cameras has a resolution no greater than eight megapixels.

4. The refrigerator appliance of claim 2, wherein each of the two cameras is positioned no more than five centimeters from each other within each of the plurality of collocated camera assemblies.

5. The refrigerator appliance of claim 1, wherein the plurality of collocated camera assemblies comprises no less than four collocated camera assemblies.

6. The refrigerator appliance of claim 5, wherein the plurality of collocated camera assemblies are positioned coplanar at a front portion of the fresh food chamber.

7. The refrigerator appliance of claim 5, wherein each of the four collocated camera assemblies is positioned coplanar at a front portion of the fresh food chamber proximate a respective corner of the fresh food chamber.

8. The refrigerator appliance of claim 1, wherein a plurality of shelves is mounted to the cabinet within the fresh food chamber.

9. The refrigerator appliance of claim 1, each camera of the plurality of collocated camera assemblies has a resolution no greater than three megapixels.

10. The refrigerator appliance of claim 9, wherein the plurality of collocated camera assemblies captures images with no less than one hundred and fifty pixels per centimeter for no less than sixty percent of the plane.

11. An appliance, comprising:
a cabinet defining an interior chamber; and
a plurality of collocated camera assemblies mounted to the cabinet at the interior chamber, the plurality of collocated camera assemblies oriented for capturing images of a plane in the interior chamber.

12. The appliance of claim 11, wherein each of the plurality of collocated camera assemblies comprises two cameras with different focal lengths.

13. The appliance of claim 12, wherein each of the two cameras has a resolution no greater than eight megapixels.

14. The appliance of claim 12, wherein each of the two cameras is positioned no more than five centimeters from each other within each of the plurality of collocated camera assemblies.

15. The appliance of claim 11, wherein the plurality of collocated camera assemblies comprises no less than four collocated camera assemblies.

16. The appliance of claim 15, wherein the plurality of collocated camera assemblies are positioned coplanar at a front portion of the interior chamber.

17. The appliance of claim 15, wherein each of the four collocated camera assemblies is positioned coplanar at a front portion of the interior chamber proximate a respective corner of the interior chamber.

18. The appliance of claim 11, each camera of the plurality of collocated camera assemblies has a resolution no greater than three megapixels.

19. The appliance of claim 18, wherein the plurality of collocated camera assemblies captures images with no less than one hundred and fifty pixels per centimeter for no less than sixty percent of the plane.
